(19) United States
(12) Patent Application Publication
(10) Pub. No.: US 2026/0211148 A1
(43) Pub. Date: Jul. 23, 2026

(54) ORIENTING AN UNDERGROUND DETECTOR FOR MUON TOMOGRAPHY

(71) Applicant: KoBold Metals Company, Berkeley, CA (US)

(72) Inventors: Daniel Snowden-Ifft, Berkeley, CA (US); Thomas Hunt, Berkeley, CA (US); William Page, Berkeley, CA (US); Jean-Luc Gauvreau, Berkeley, CA (US)

(21) Appl. No.: 18/639,193

(22) Filed: Apr. 18, 2024

Related U.S. Application Data
(60) Provisional application No. 63/460,254, filed on Apr. 18, 2023.

(51) Int. Cl. G01V 5/04

(52) U.S. Cl. CPC G01V 5/04

(57) ABSTRACT

Systems and methods for orienting an underground muon detector include receiving measurements of detected muons from at least one muon detector deployed in a borehole in a subsurface formation. A measured field of muon detections per steradian over the field of view of the at least one muon detector is generated based on the received measurements; a null field representing an expected rate of muon detections per steradian over a field of view of the at least one muon detector is generated. A misfit parameter is calculated between the measured field and the null field, and the misfit parameter is minimized to align the measured field to the null field. An orientation of the at least one muon detector with respect to a vertical reference and known markers near the at least one muon detector is determined.

### CLAIM OF PRIORITY

This application claims priority under 35 USC § 119(e) to U.S. patent application Ser. No. 63/460,254, filed on Apr. 18, 2023, the entire contents of which are hereby incorporated by reference.

### FIELD OF THE DISCLOSURE

The disclosure relates to muon tomography and more particularly, to the orientation of muon detectors for underground exploration.

### BACKGROUND

Muon tomography is a technique that uses cosmic ray muons to generate three-dimensional images of volumes based on the absorption of muons. Muons are much more deeply penetrating than X-rays, so muon tomography can be used to image through much thicker volumes of material than X-ray-based tomography, for example.

Cosmic rays generate muons in the Earth's upper atmosphere that travel in straight lines at close to the speed of light. The atmospheric muons that penetrate the Earth's surface lose energy as they encounter material of different densities. Use of atmospheric muons as an imaging tool is described, for example, in a publication by L. Bonechi et al., Reviews in Physics, 5 (2020). Muon tomography has been used in a wide variety of fields including archeology, planetary science, homeland defense, civil engineering, and geology.

Subsurface detectors can be used to survey depths up to about 1 km. Data from the detectors can be used to generate a three-dimensional map of subsurface density anomalies, including mineral deposits.

### SUMMARY

This specification describes methods and systems for orienting muon detectors within a subsurface formation. A data processing system receives measurements of detected muons from at least one muon detector deployed in a borehole drilled into the subsurface formation. Based on the received measurements, the data processing system generates a three-dimensional (3D) map of the subsurface. The data processing system also generates a null field representing the expected rate of muon detections by the muon detector per steradian of the field of view of the detector. The data processing system calculates a misfit parameter between the 3D map of the subsurface and the null field. The data processing system aligns the 3D map of the subsurface with the null field by minimizing the misfit parameter. Based on the aligning, the data processing system determines an orientation of the muon detector with respect to a coordinate system of the null field.

The methods and systems enable one or more of the following technical advantages. Conventional methods of determining the orientation of muon detectors include using the Earth's magnetic field and using hardware such as gyroscopes and accelerometers installed on the muon detectors. Such hardware uses additional power supplied to the detector, increases the cost and complexity of the muon detector, and the hardware can be subject to measurement drift overtime introducing errors into the orientation of the muon detector. To overcome these issues, the data processing system determines the orientation of muon detectors using muon trajectories does not rely on additional sensors and hardware onboard the muon detector to determine orientation thereby reducing the overall cost and complexity of the system. When additional sensors and hardware are available, the DAPS can use the orientation determined using muon trajectories to improve an orientation determined based on the additional sensors and hardware. The data processing system can use measurements from multiple muon detectors in a single borehole. Since the data processing system orients the muon detector with respect to known surfaces and/or density features, there is high confidence that the determined orientation is accurate.

One or more of these advantages are enabled by one or more of the following examples.

In one aspect, a method for orienting an underground muon detector includes receiving measurements of detected muons from at least one muon detector deployed in a borehole in a subsurface formation; generating a measured field of muon detections per steradian over the field of view of the at least one muon detector based on the received measurements; generating a null field representing an expected rate of muon detections per steradian over a field of view of the at least one muon detector; calculating a misfit parameter between the measured field and the null field; aligning the measured field to the null field by minimizing the misfit parameter; and determining an orientation of the at least one muon detector with respect to a vertical reference and known markers near the at least one muon detector.

In one aspect, a system for orienting an underground muon detector includes at least one muon detector; at least one processor; a memory storing instructions that, when executed by the at least one processor, cause the at least one processor to perform operations including receiving measurements of detected muons from at least one muon detector deployed in a borehole in a subsurface formation; generating a measured field of muon detections per steradian over the field of view of the at least one muon detector based on the received measurements; generating a null field representing an expected rate of muon detections per steradian over a field of view of the at least one muon detector; calculating a misfit parameter between the measured field and the null field; aligning the measured field to the null field by minimizing the misfit parameter; and determining an orientation of the at least one muon detector with respect to a vertical reference and known markers near the at least one muon detector.

In one aspect, one or more non-transitory machine-readable storage devices storing instructions for orienting an underground muon detector, the instructions being executable by one or more processing devices to cause performance of operations including receiving measurements of detected muons from at least one muon detector deployed in a borehole in a subsurface formation; generating a measured field of muon detections per steradian over the field of view of the at least one muon detector based on the received measurements; generating a null field representing an expected rate of muon detections per steradian over a field of view of the at least one muon detector; calculating a misfit parameter between the measured field and the null field; aligning the measured field to the null field by minimizing the misfit parameter; and determining an orientation of the at least one muon detector with respect to a vertical reference and known markers near the at least one muon detector.

Examples of these aspects can include one or more of the following features.

In some examples, generating the null field is based on at least one of a surface topographical map, a density profile of the subsurface, and a muon energy loss model.

In some examples, calculating a misfit parameter includes identifying at least one feature in both the null field and the measured field; and calculating a distance between a location of the at least one feature identified in the null field and a location of the at least one feature identified in the measured field.

In some cases, identifying at least one feature includes identifying a man-made surface feature.

In some examples, the aligning includes rotating and tilting a coordinate system of the measured field with respect to the coordinate system of the null field by altering values of an azimuth angle and a zenith angle of the at least one muon detector.

In some cases, the aligning includes translating the coordinate system of the measured field with respect to the coordinate system of the null field by altering values of a depth or a location in three-dimensional space of the at least one muon detector.

In some examples, these aspects include determining a direction from the at least one muon detector to a density anomaly in the subsurface formation.

In some cases, determining a direction to a density anomaly includes subtracting the null field from the measured field.

In some examples, these aspects include determining an orientation of two or more muon detectors relative to each other.

In some examples, these aspects include determining a location of a density anomaly relative to the two or more muon detectors based on overlapping fields of view of the two or more muon detectors.

In some examples, these aspects include generating a three-dimensional subsurface map of the subsurface formation based on the determined orientation of the at least one muon detector and the measured field.

In some examples, these aspects include integrating the determined orientation of the at least one muon detector with a second orientation of the at least one muon detector determined using at least one of borehole trajectory, depth, acceleration, and magnetic field.

In some examples, calculating a misfit parameter includes identifying at least one feature in both the null field and the measured field; and calculating a distance between the location of the at least one feature identified in the null field and the location of the at least one feature identified in the measured field.

In some examples, the aligning includes rotating and tilting a coordinate system of the measured field with respect to the coordinate system of the null field by altering the values of an azimuth angle and a zenith angle of the at least one muon detector to minimize the misfit parameter.

In some examples, the at least one muon detector includes a gas electron multiplier muon detector.

Other advantages will be apparent from the description below, the figures, and the claims.

### DESCRIPTION OF DRAWINGS

FIG. 1A is a cross-sectional schematic view of an example of a muon detector suitable for a muon tomography system.

FIG. 1B is a plain view of the muon detector shown in FIG. 1A.

FIG. 2 is a flow chart of an example method for orienting muon detectors.

FIGS. 3A-3B are schematic diagrams of example muon transmissions through surface features.

FIG. 4 is a schematic figure showing portions of an example muon tomography system with multiple muon detectors deployed underground.

FIG. 5 is a schematic of an example muon tomography system with multiple muon detectors deployed down a single borehole on the same cabling.

FIG. 6 is a schematic diagram of an example electronic processing apparatus suitable for use in a muon tomography system.

### DETAILED DESCRIPTION

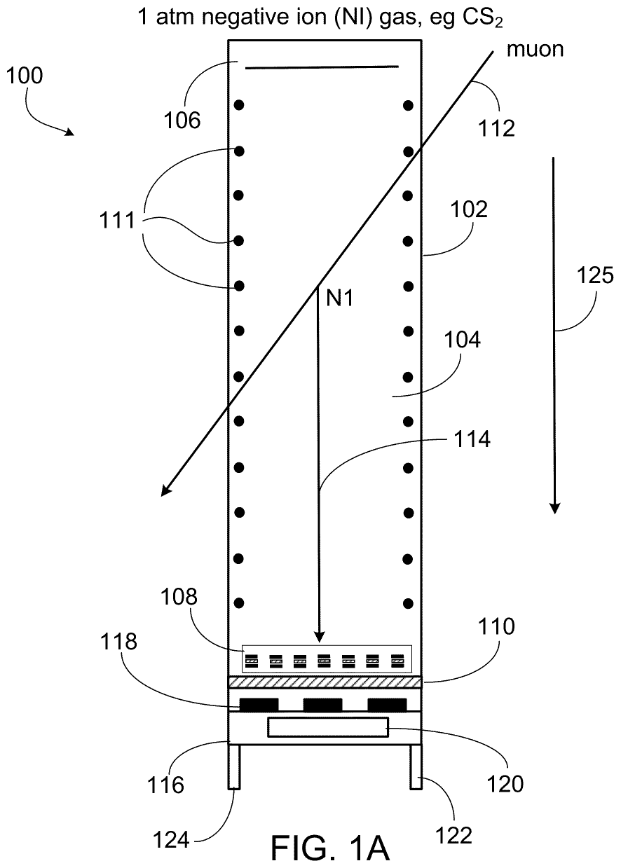

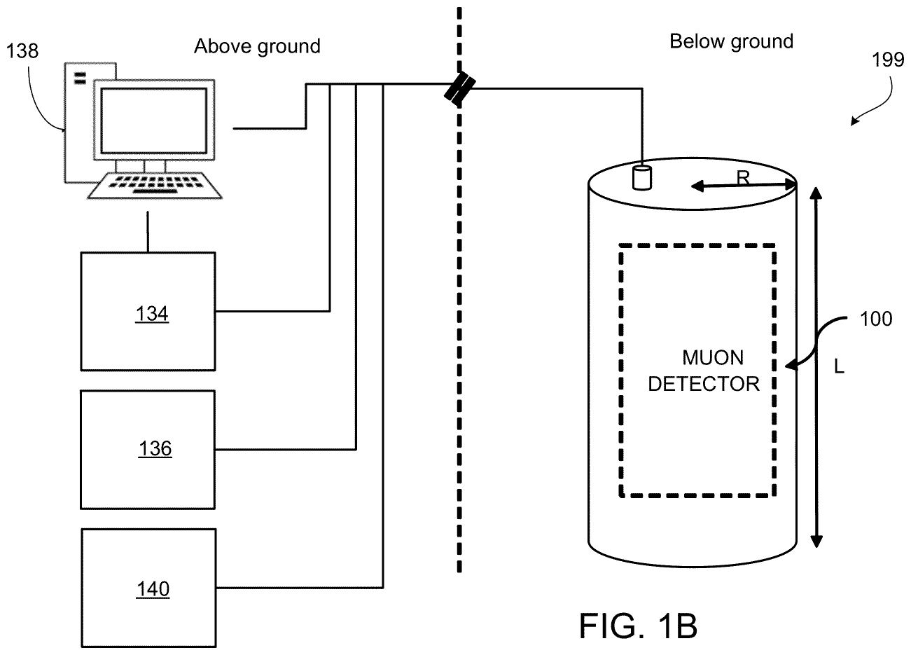

Referring to FIG. 1A, an example of a muon detector 100 suitable for a muon tomography system is shown schematically in cross-section. The muon detector 100 has a form factor suitable for deployment down a borehole. In particular, the muon detector 100 has a long dimension extending along an axis 125, and shorter dimensions orthogonal to axis 125. In some examples, the detector 100 is cylindrical or near-cylindrical in shape. The short dimension can be, at most, about 30 cm or less (e.g., 25 cm or less, 20 cm or less, 15 cm or less, 10 cm or less), while the long dimension can be about 50 cm or more (e.g., 75 cm or more, 100 cm or more, such as up to 200 cm).

The muon detector 100 includes a drift cathode 106, a gas electron multiplier (GEM) 108, an anode 110, and readout electronics 118 mounted in order along axis 125 inside a closed chamber 102. The cathode 106 is located at one end of the chamber and the GEM 108, cathode 106, and readout electronics 118 are located at the opposite end. Chamber 102 is a sealed enclosure containing a gas 104. Ports for a gas inlet 122 and another one for gas outlet 124 are provided. A series of ring electrodes 111 are positioned at a series of axial locations along the length of the chamber 102 between cathode 106 and GEM 108. In some implementations, the muon detector can have more than one GEM for longevity of the detector and/or amplification of the signal.

Generally, the gas 104 has a composition and pressure selected so that passage of a muon 112 through the chamber causes sufficient ionization for reliable detection. In some implementations, the gas 104 is a negative ion 114 gas, such as carbon disulfide (CS₂) gas. Gas mixtures can also be used, such as a mixture of Argon and CO₂ (e.g., at a ratio of about 70% Argon to about 30% CO₂). The gas 104 can have a pressure in a range of between 0.1 atmospheres (atm) to 10 atm, e.g., at about 1 atm. Pressure of the gas can be maintained while the detector 100 is deployed downhole via gas lines connected to inlet 122 and outlet 124.

In general, the chamber 102 is formed from a material or materials that have sufficient mechanical strength to reliably maintain the integrity of the chamber during deployment, which can involve being in a high pressure, high heat environment for weeks or months at a time. The chamber 102 can be made from a metal or alloy (e.g., stainless steel, aluminum), or other material having high mechanical strength.

The readout electronics 118 are supported on a printed circuit board (PCB) 116 which is placed inside the chamber 102 and are directly connected to the anode 110.

The cathode 106, GEM 108, anode 110, and the readout electronics 118 are powered by an internal power supply 120 (e.g., a battery) housed inside the chamber 102.

During operation, the cathode 106, anode 110, and electrodes 111 are energized to provide an electric field in the chamber, e.g., with field lines parallel to axis 125. Negative ions (e.g., 114) formed in gas 104 by the passage of muon 112 drift parallel to axis 125 until they reach GEM 108. Although a single ion path 114 is illustrated in FIG. 1A, in reality the muon 112 will generate ions along its entire path from when it enters chamber 102 until it exits. GEM 108 receives ions 114 formed in the chamber 102 between the anode 110 and the cathode 106 and generates an avalanche of electrons in response to each ion. The electron avalanche from GEM 108 generates a current in the anode 110.

More specifically, the anode 110 includes a mesh of wires and the electrode avalanche generates a current at the wires in the mesh adjacent to the location of the GEM where the avalanche occurs. The current produces a signal in the corresponding wire that is detectable by the readout electronics 118. Because a single muon will generate a string of ions as it passes through the chamber, and because the relative timing of the corresponding signal from each wire will depend on the propagation direction of the muon through the chamber, detector 100 can provide information about both the number of muons passing through the chamber and the direction of travel of each one.

Muon detector 100 is an example of a time projection chamber (TPC) which is a particle detector that uses a combination of electric fields and magnetic fields together with a sensitive volume of gas or liquid to perform a three-dimensional reconstruction of a particle trajectory or interaction.

Alternative designs are possible. For example, in some examples, a muon detector can include two anodes and two GEMs, one of each located at opposing ends of the chamber with the cathode in between.

Although the example muon detector 100 is shown to be a GEM muon detector, other types of muon detectors can be used. For example, scintillating and nuclear emulsion type detectors can be used.

Referring to FIG. 1B, a muon tomography system 199 that includes the muon detector 100 also includes a data acquisition and processing system (DAPS) 138 for processing data from the detector 100. The DAPS 138 uses a software program 134 (e.g., custom software or software based on a commercially-available platform, such as LabVIEW) for data processing and analysis. In the implementation depicted, DAPS 130 and detector 100 are also connected to an external power supply 136. As discussed further below, when deployed, DAPS 138 and external power supply 136 can be located at the surface, connected via cabling to the muon detector 100 downhole.

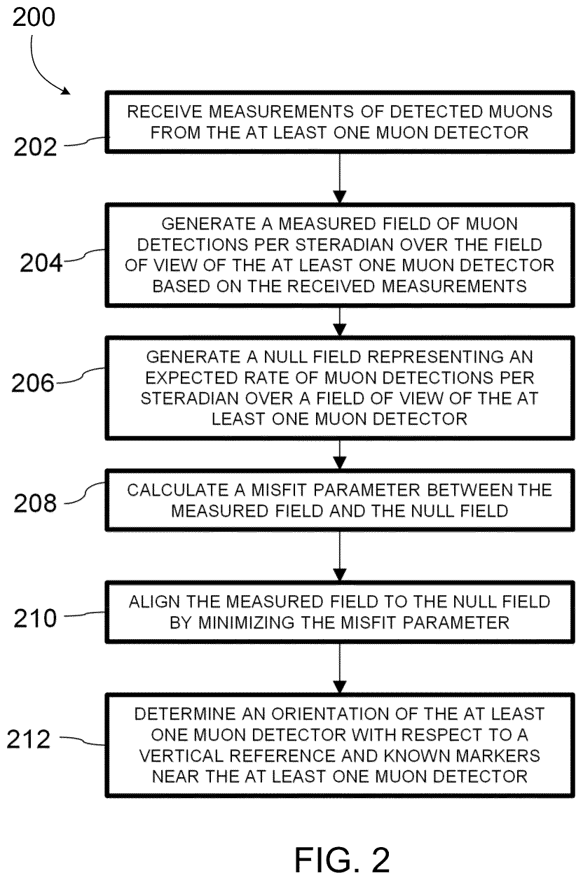

FIG. 2 is a flow chart of an example method 200 for orienting a muon detector (e.g., 100) in a borehole. The DAPS receives measurements of detected muons from at least one muon detector deployed in a borehole of a subsurface formation (step 202). Based on the received measurements, the DAPS generates a measured field of muon detections per steradian over the field of view of the muon detector (step 204). In some implementations, the measured field is initially oriented with an expected orientation of the muon detector.

The DAPS generates a null field representing an expected rate of muon detections per steradian over a field of view of the muon detector (step 206). The null field accounts for known surface topography and known density variations in the subsurface such as mineral deposits. For constant subsurface density, muons having a longer subsurface path to the detector (e.g., muons passing through a raised portion of the surface) are expected to arrive at the detector in smaller numbers than muons traversing a shorter path. For muons collected over similar zenith angles, fewer detection events could be misinterpreted as an over dense mineral deposit where surface variations are unaccounted for.

In some implementations, the null field can be numerically calculated using a topographical map of the area, density profiles, if known, and/or the physics of cosmic ray muon energy loss. Therefore, the null field represents the expected detection rate for muons as seen by the detector as a function of zenith and azimuthal angles, typically with a model of subsurface density. Exploration occurs by comparing the measured field to the null field with any significant differences indicating a potential discovery. For example, an ore body between the detector and the sky, which is denser than the modeled subsurface density in the null field can reduce the muon count across the solid angle subtended by the ore body. The ore body can be detected and characterized by the reduction in muon count.

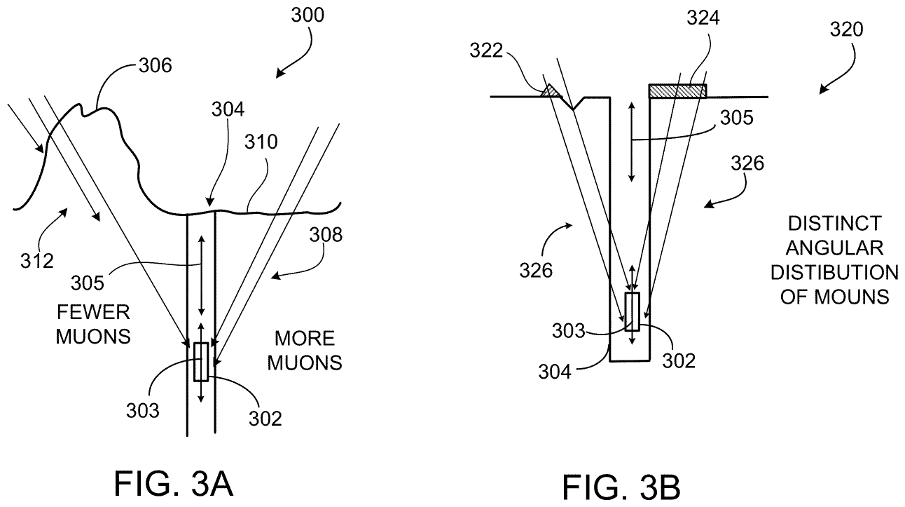

FIG. 3A shows a schematic diagram 300 of example muon transmission from the atmosphere to a muon detector 302 in a borehole 304. In this example, a surface feature 306 (here, a hill) exists on the surface of the formation. Muon absorption by the subsurface formation depends on both the density of the formation and the path length of the muon in the subsurface formation. Higher densities and longer path lengths absorb more muons than less dense formations and/or shorter paths. Detector 302 detects muons 308 traveling along a path at a particular zenith angle that pass through a flat surface 310 at a first range of azimuthal angles and detects muons 312 traveling along another path at the same zenith angle but at a different range of azimuthal angles that pass through the feature 306. Here, the zenith angle refers to the angle with respect to the detector axis 303 (which is shown parallel to the borehole axis 305). The azimuthal angle refers to the orientation angle in a plane perpendicular to the detector axis 303. Because the path length through the earth of muons 308 is shorter than the path length of muons 312, muons 308 will, over time, arrive at the muon detector 302 in larger numbers than the muons 312. Thus, if the terrain feature 306 is not accounted for in the null field of the formation, different muon detection rates could be attributable to higher density formations for muons 312 rather than longer path lengths.

The DAPS calculates a misfit parameter between the 3D subsurface map generated based on measurements from the muon detector and the null field (step 208). For example, the DAPS calculates the misfit parameter by subtracting the expected muon count as a function of angle (null field) from the measured muon count as a function of angle (measured field). The misfit parameter is a representation of errors/differences between the null field and the measured field. In some implementations, the misfit parameter can be a distance between a location of a surface feature expressed in the null field coordinate system and a location of the same surface feature in the 3D subsurface map expressed in the coordinate system of the 3D subsurface map. While in the present example, surface feature 306 is a hill, more generally surface features can include other surface formations that can affect the muon detection rate to cause it to deviate from an average rate for a particular zenith direction. Other such surface features include both raised areas of land including hills, mountains, crags, and other prominences, or depressions such as valleys, ravines, gullies, etc.

The DAPS aligns the 3D subsurface map (e.g., measured field) with the null field by minimizing the misfit parameter (step 210). In some implementations, the DAPS alters the value of an azimuth angle (rotation) and a zenith angle (tilt) of the muon detector to rotate and tilt a coordinate system of the 3D subsurface map relative to the coordinate system of the null field. In these implementations, the azimuth angle and the zenith angle are free parameters in the minimization of the misfit parameter.

In some implementations, when significant density variations (e.g., surface topological features and known underground density anomalies) are present in the null field and in the 3D subsurface map, the alignment can be done using a first order fitting using a smaller data set than might otherwise be used. More difficult to detect variations, such as from mineral deposits, may not be present in smaller data sets and will therefore not meaningfully interfere with a first order fit. For example, a dataset to resolve a density anomaly from a mineral deposit can be 5 to 10 times larger than the dataset to determine an orientation of the detector. The relative dataset size between the dataset to determine orientation and a dataset to resolve a density anomaly can be related to the angular size of the density anomaly compared with the angular size over which a muon detector can detect muons. In an example implementation, a size of a density anomaly is 5 to 10 times smaller than the scale over which the detector receives muon detections. At a 150 meter depth, for instance, it can take 20 to 30 days to resolve the anomaly. At a 300 meter depth it can take about 250 days to resolve the density anomaly. In contrast, the dataset to determine the orientation can be collected in 2 to 6 days at 150 meters depth and in 25 to 50 days at 300 meters depth.

If no meaningful surface variations exist for this orientation procedure, a man-made feature can be created, for example, by using an excavator to dig a hole and pile up the dirt obtained. A man-made feature can create a relatively unique signature in the signal received by the muon detector, such as a dipole signature. Other man-made structures which are easy to identify in the measured field are also possible to use, such as existing roads and drill pads.

FIG. 3B shows an example arrangement 320 of a subsurface formation with an engineered surface feature 322, such as a hole dug by an excavator, and an existing man-made structure 324, such as a road, drill pad, or building. The muons 326 passing through either the engineered feature 322 or the man-made structure 324 will result in a distinct angular distribution that can be recognizable in the detected measurements.

The DAPS determines an orientation of the muon detector based on the alignment of the null field and the generated 3D subsurface map (step 212). The alignment procedure provides quantitative information about the detector's tilt with respect to the vertical and the detector's rotation with respect to known markers near the detector site. This orientation procedure would need to be repeated any time the detector is moved.

In some implementations, determining the orientation of the detector includes using muon trajectories to augment other data such as depth, borehole trajectory, and geomagnetic sensors onboard the detector. For example, the DAPS can use the muon trajectories to improve an orientation determined using data from accelerometers, gyroscopes, geomagnetic sensors, borehole trajectory, and/or depth of the muon detector in the borehole.

In some implementations, the method 200 includes modeling muon flux and attenuation through the terrain of the subsurface formation, followed by minimization of the misfit of the muon flux as a function of angle through the detector with the detector orientation as free parameters. In some implementations, detector depth or location in 3D space are determined as additional free parameters if the depth and/or trajectory of the borehole is unknown.

In some implementations, the muon detector is used to identify density anomalies along the path between the detector and the surface of the earth. In some implementations, the DAPS generates a 3D subsurface map of the subsurface formation based on the determined orientation of the muon detector and the measured field. The accuracy of a generated 3D subsurface map depends on determining an accurate orientation of the detector. After determining the detector orientation, the expected muon flux as a function of angle (e.g., null field) is taken into account to determine the direction of density anomalies in the subsurface formation. In some implementations, the DAPS subtracts the null field from the actual muon flux (e.g., measured field) as a function of angle at the detector to determine the direction from the muon detector to the density anomaly.

In some implementations, multiple detectors on a string of detectors may each be oriented with respect to each other and with respect to the surface using the method 200. Overlapping fields of view from multiple detectors oriented using this technique can further constrain the location of density anomalies. In some implementations, muon flux data from multiple detectors is used to refine the null field.

In some implementations, detector orientation of one or more detectors can also be used as free parameters in an inversion or parametric inversion to determine the location of density anomalies. The DAPS can invert muon rates as a function of zenith and azimuth angle with respect to the detector to estimate a 3D density of the subsurface based on the null field and the detector orientation with respect to the 3D subsurface. The inversion to detect anomalies may also fit other data, such as gravity, magnetic, or electromagnetic data in addition to muon flux and trajectory data from borehole detectors.

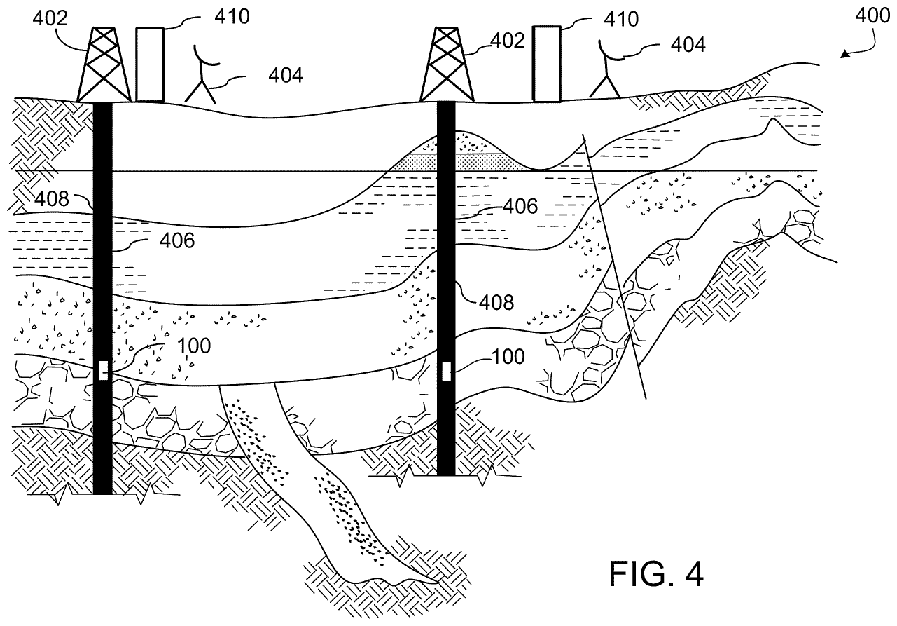

FIG. 4 is a schematic showing portions of an example muon tomography system 400 with multiple muon detectors 100 deployed underground. At each borehole of interest 406 a station with a deck tower 402, network tower 404, and control station 410 is established. The detector 100 is run down the borehole on a string 408. In some implementations, each muon detector has its own electronic processing apparatus (e.g., at the surface and connected to network towers 404). Alternatively, all muon detectors can have a common electronic processing apparatus. The electronic processing apparatus can be in communication with each of the muon detectors and programmed to receive the data, to calculate the direction of muons passing through each of the muon detectors, and to determine information about subterranean mineral deposits based on the direction of the muons, and the location of each of the muon detectors when deployed down one or more boreholes. In some implementations, the cabling suspends the muon detectors 100 at different depths down their respective boreholes.

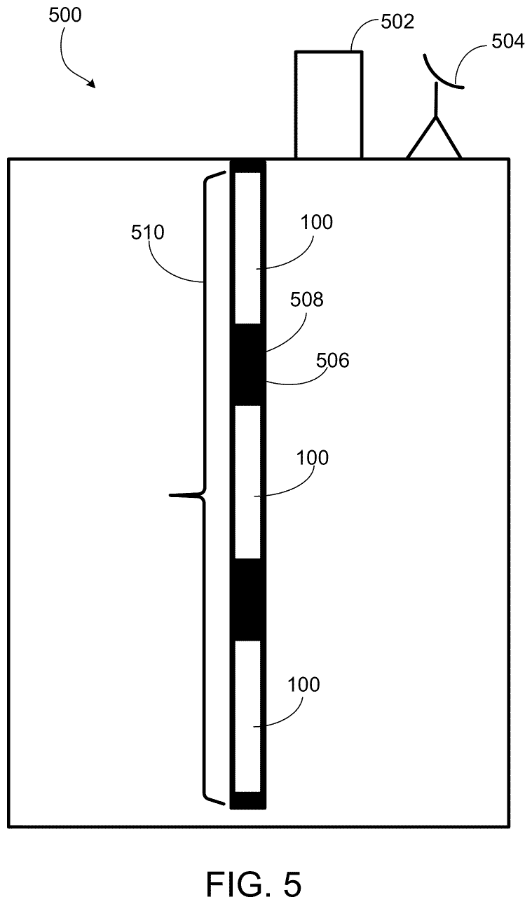

While the system shown in FIG. 4 depicts a single muon detector deployed down each borehole, other arrangements are possible. For example, multiple muon detectors can be deployed down a single borehole and positioned at different depths underground. FIG. 5 is a schematic FIG. 500 showing portions of an example muon tomography system 510 with multiple muon detectors 100 deployed down a single borehole 506 on the same cabling 508. This type of configuration can be used for long-term, remote running having the control station 502 and network tower 504 installed at the borehole with the possibility for occasional visits. The control station 502 collects the local data and then transfers it via the network tower 504 to a remote location for further analysis.

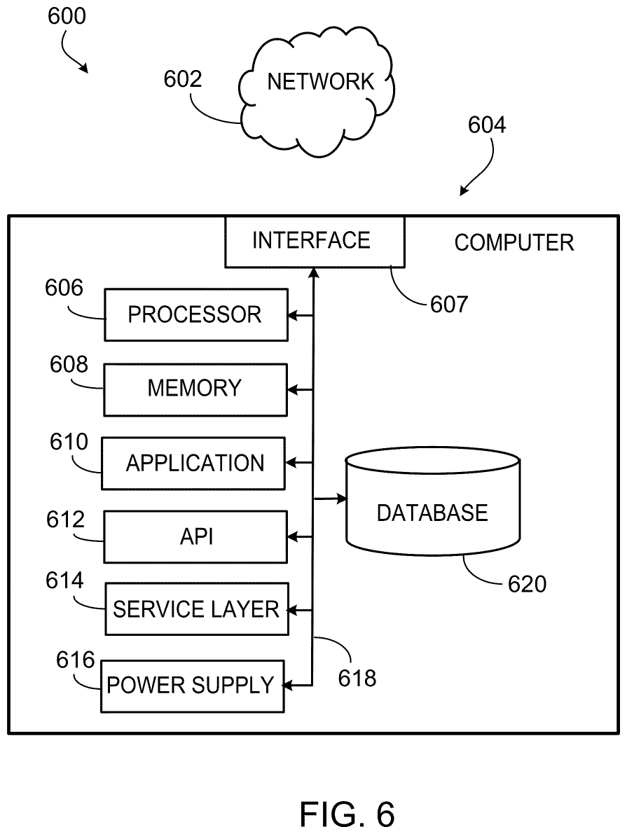

FIG. 6 is a block diagram 600 of an example computer system 604 used to provide computational functionalities associated with described algorithms, methods, functions, processes, flows, and procedures described in the present disclosure, according to some implementations of the present disclosure. The illustrated computer 604 is intended to encompass any computing device such as a server, a desktop computer, a laptop/notebook computer, a wireless data port, a smartphone, a personal data assistant (PDA), a tablet computing device, or one or more processors within these devices, including physical instances, virtual instances, or both. The computer 604 can include input devices such as keypads, keyboards, and touch screens that can accept user information. Also, the computer 604 can include output devices that can convey information associated with the operation of the computer 604. The information can include digital data, visual data, audio information, or a combination of information. The information can be presented in a graphical user interface (UI) (or GUI).

The computer 604 can serve in a role as a client, a network component, a server, a database, a persistency, or components of a computer system for performing the subject matter described in the present disclosure. The illustrated computer 604 is communicably coupled with a network 602. In some implementations, one or more components of the computer 604 can be configured to operate within different environments, including cloud-computing-based environments, local environments, global environments, and combinations of environments.

At a high level, the computer 604 is an electronic computing device operable to receive, transmit, process, store, and manage data and information associated with the described subject matter. According to some implementations, the computer 604 can also include, or be communicably coupled with, an application server, an email server, a web server, a caching server, a streaming data server, or a combination of servers.

The computer 604 can receive requests over network 602 from a client application (for example, executing on another computer 604). The computer 604 can respond to the received requests by processing the received requests using software applications. Requests can also be sent to the computer 604 from internal users (for example, from a command console), external (or third) parties, automated applications, entities, individuals, systems, and computers. Each of the components of the computer 604 can communicate using a system bus 618. In some implementations, any or all of the components of the computer 604, including hardware or software components, can interface with each other or the interface 607 (or a combination of both), over the system bus 618. Interfaces can use an application programming interface (API) 612, a service layer 614, or a combination of the API 612 and service layer 614. The API 612 can include specifications for routines, data structures, and object classes. The API 612 can be either computer-language independent or dependent. The API 612 can refer to a complete interface, a single function, or a set of APIs.

The service layer 614 can provide software services to the computer 604 and other components (whether illustrated or not) that are communicably coupled to the computer 604. The functionality of the computer 604 can be accessible for all service consumers using this service layer. Software services, such as those provided by service layer 614, can provide reusable, defined functionalities through a defined interface. For example, the interface can be software written in JAVA, C++, or a language providing data in extensible markup language (XML) format. While illustrated as an integrated component of the computer 604, in alternative implementations, the API 612 or the service layer 614 can be stand-alone components in relation to other components of the computer 604 and other components communicably coupled to the computer 604. Moreover, any or all parts of the API 612 or the service layer 614 can be implemented as child or sub-modules of another software module, enterprise application, or hardware module without departing from the scope of the present disclosure. The computer 604 includes an interface 607. Although illustrated as a single interface 607 in FIG. 6, two or more interfaces 607 can be used according to particular needs, desires, or particular implementations of the computer 604 and the described functionality. The interface 607 can be used by the computer 604 for communicating with other systems that are connected to the network 602 (whether illustrated or not) in a distributed environment. Generally, the interface 607 can include, or be implemented using, logic encoded in software or hardware (or a combination of software and hardware) operable to communicate with the network 602. More specifically, the interface 607 can include software supporting one or more communication protocols associated with communications. As such, the network 602 or the interface's hardware can be operable to communicate physical signals within and outside of the illustrated computer 604.

The computer 604 includes a processor 606. Although illustrated as a single processor 606 in FIG. 6, two or more processors 606 can be used according to particular needs, desires, or particular implementations of the computer 604 and the described functionality. Generally, the processor 606 can execute instructions and can manipulate data to perform the operations of the computer 604, including operations using algorithms, methods, functions, processes, flows, and procedures as described in the present disclosure.

The computer 604 also includes a database 820 that can hold data for the computer 604 and other components connected to the network 602 (whether illustrated or not). For example, database 820 can be an in-memory, conventional, or a database storing data consistent with the present disclosure. In some implementations, database 820 can be a combination of two or more different database types (for example, hybrid in-memory and conventional databases) according to particular needs, desires, or particular implementations of the computer 604 and the described functionality. Although illustrated as a single database 820 in FIG. 6, two or more databases (of the same, different, or combination of types) can be used according to particular needs, desires, or particular implementations of the computer 604 and the described functionality. While database 820 is illustrated as an internal component of the computer 604, in alternative implementations, database 820 can be external to the computer 604.

The computer 604 also includes a memory 608 that can hold data for the computer 604 or a combination of components connected to the network 602 (whether illustrated or not). Memory 608 can store any data consistent with the present disclosure. In some implementations, memory 608 can be a combination of two or more different types of memory (for example, a combination of semiconductor and magnetic storage) according to particular needs, desires, or particular implementations of the computer 604 and the described functionality. Although illustrated as a single memory 608 in FIG. 6, two or more memories 608 (of the same, different, or combination of types) can be used according to particular needs, desires, or particular implementations of the computer 604 and the described functionality. While memory 608 is illustrated as an internal component of the computer 604, in alternative implementations, memory 608 can be external to the computer 604.

The application 610 can be an algorithmic software engine providing functionality according to particular needs, desires, or particular implementations of the computer 604 and the described functionality. For example, application 610 can serve as one or more components, modules, or applications. Further, although illustrated as a single application 610, the application 610 can be implemented as multiple applications 610 on the computer 604. In addition, although illustrated as internal to the computer 604, in alternative implementations, the application 610 can be external to the computer 604.

The computer 604 can also include a power supply 616. The power supply 616 can include a rechargeable or non-rechargeable battery that can be configured to be either user-or non-user-replaceable. In some implementations, the power supply 616 can include power-conversion and management circuits, including recharging, standby, and power management functionalities. In some implementations, the power-supply 616 can include a power plug to allow the computer 604 to be plugged into a wall socket or a power source to, for example, power the computer 604 or recharge a rechargeable battery.

There can be any number of computers 604 associated with, or external to, a computer system containing computer 604, with each computer 604 communicating over network 602. Further, the terms “client,” “user,” and other appropriate terminology can be used interchangeably, as appropriate, without departing from the scope of the present disclosure. Moreover, the present disclosure contemplates that many users can use one computer 604 and one user can use multiple computers 604.

Implementations of the subject matter and the functional operations described in this specification can be implemented in digital electronic circuitry, intangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially-generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 602.11 a/b/g/n or 602.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of examples of these systems and methods have been described. Nevertheless, it will be understood that various modifications may be made without departing from the spirit and scope of this disclosure. Accordingly, other examples are within the scope of the following claims.

What is claimed is:

1. A method for orienting an underground muon detector, the method comprising:
receiving measurements of detected muons from at least one muon detector deployed in a borehole in a subsurface formation;
generating a measured field of muon detections per steradian over the field of view of the at least one muon detector based on the received measurements;
generating a null field representing an expected rate of muon detections per steradian over a field of view of the at least one muon detector;
calculating a misfit parameter between the measured field and the null field;
aligning the measured field to the null field by minimizing the misfit parameter; and
determining an orientation of the at least one muon detector with respect to a vertical reference and known markers near the at least one muon detector.

2. The method of claim 1, wherein generating the null field is based on at least one of a surface topographical map, a density profile of the subsurface, and a muon energy loss model.

3. The method of claim 1, wherein calculating a misfit parameter comprises identifying at least one feature in both the null field and the measured field; and calculating a distance between a location of the at least one feature identified in the null field and a location of the at least one feature identified in the measured field.

4. The method of claim 3, wherein identifying at least one feature comprises identifying a man-made surface feature.

5. The method of claim 1, wherein the aligning comprises rotating and tilting a coordinate system of the measured field with respect to the coordinate system of the null field by altering values of an azimuth angle and a zenith angle of the at least one muon detector.

6. The method of claim 5, wherein the aligning further comprises translating the coordinate system of the measured field with respect to the coordinate system of the null field by altering values of a depth or a location in three-dimensional space of the at least one muon detector.

7. The method of claim 1, further comprising determining a direction from the at least one muon detector to a density anomaly in the subsurface formation.

8. The method of claim 7, wherein determining a direction to a density anomaly comprises subtracting the null field from the measured field.

9. The method of claim 1, further comprising determining an orientation of two or more muon detectors relative to each other.

10. The method of claim 9, further comprising determining a location of a density anomaly relative to the two or more muon detectors based on overlapping fields of view of the two or more muon detectors.

11. The method of claim 1, further comprising generating a three-dimensional subsurface map of the subsurface formation based on the determined orientation of the at least one muon detector and the measured field.

12. The method of claim 1, further comprising integrating the determined orientation of the at least one muon detector with a second orientation of the at least one muon detector determined using at least one of borehole trajectory, depth, acceleration, and magnetic field.

13. A system for orienting an underground muon detector, the system comprising:
at least one muon detector;
at least one processor;
a memory storing instructions that, when executed by the at least one processor, cause the at least one processor to perform operations comprising:
receiving measurements of detected muons from at least one muon detector deployed in a borehole in a subsurface formation;
generating a measured field of muon detections per steradian over the field of view of the at least one muon detector based on the received measurements;
generating a null field representing an expected rate of muon detections per steradian over a field of view of the at least one muon detector;
calculating a misfit parameter between the measured field and the null field;
aligning the measured field to the null field by minimizing the misfit parameter; and
determining an orientation of the at least one muon detector with respect to a vertical reference and known markers near the at least one muon detector.

14. The system of claim 13, wherein calculating a misfit parameter comprises identifying at least one feature in both the null field and the measured field; and calculating a distance between a location of the at least one feature identified in the null field and a location of the at least one feature identified in the measured field.

15. The system of claim 13, wherein the aligning comprises rotating and tilting a coordinate system of the measured field with respect to the coordinate system of the null field by altering values of an azimuth angle and a zenith angle of the at least one muon detector to minimize the misfit parameter.

16. The system of claim 13, the operations further comprising determining an orientation of two or more muon detectors relative to each other; and determining a location of a density anomaly relative to the two or more muon detectors based on overlapping fields of view of the two or more muon detectors.

17. The system of claim 13, further comprising generating a three-dimensional subsurface map of the subsurface formation based on the determined orientation of the at least one muon detector and the measured field.

18. The system of claim 13, wherein the at least one muon detector comprises a gas electron multiplier muon detector.

19. One or more non-transitory machine-readable storage devices storing instructions for orienting an underground muon detector, the instructions being executable by one or more processing devices to cause performance of operations comprising:
receiving measurements of detected muons from at least one muon detector deployed in a borehole in a subsurface formation;
generating a measured field of muon detections per steradian over the field of view of the at least one muon detector based on the received measurements;
generating a null field representing an expected rate of muon detections per steradian over a field of view of the at least one muon detector;
calculating a misfit parameter between the measured field and the null field;
aligning the measured field to the null field by minimizing the misfit parameter; and
determining an orientation of the at least one muon detector with respect to a vertical reference and known markers near the at least one muon detector.

20. The non-transitory machine-readable storage devices of claim 19, wherein the aligning comprises rotating and tilting a coordinate system of the measured field with respect to the coordinate system of the null field by altering values of an azimuth angle and a zenith angle of the at least one muon detector to minimize the misfit parameter.

21. The non-transitory machine-readable storage devices of claim 20, further comprising generating a three-dimensional subsurface map of the subsurface formation based on the determined orientation of the at least one muon detector and the measured field.
